(19) United States
(12) Patent Application Publication
(10) Pub. No.: US 2023/0186681 A1
(43) Pub. Date: Jun. 15, 2023

(54) COMPUTING TECHNOLOGIES FOR PREDICTING PERSONALITY TRAITS

(71) Applicant: FACEONIZED SP. Z.O.O, WARSAW (PL)

(72) Inventors: DOLORES MARTÍN SEBASTIÁ, WARSAW (PL); Tomasz KWASNIEWSKI, WARSAW (PL); Piotr Andrzej CZAYKOSWKI, WARSAW (PL)

(73) Assignee: FACEONIZED SP. Z.O.O, WARSAW (PL)

(21) Appl. No.: 17/919,513

(22) PCT Filed: Apr. 14, 2021
(86) PCT No.: PCT/EP2021/059699

§ 371 Date: Oct. 17, 2022

Related U.S. Application Data
(60) Provisional application No. 63/013,873, filed on Apr. 22, 2020.

(51) Int. Cl. G06V 40/16; G06F 16/532

(52) U.S. Cl. CPC G06V 40/171; G06V 40/166; G06F 16/532

(57) ABSTRACT

This disclosure enables various computing technologies for predicting various personality traits from various facial and ranial images of persons and then acting accordingly.

### TECHNICAL FIELD

Generally, this disclosure relates to image processing. Specifically, this disclosure relates to facial landmark detection.

### BACKGROUND

There is a desire to computationally predict various personality traits from various facial and cranial images of persons and then act accordingly. However, such technologies are not known to exist. Accordingly, this disclosure enables such technologies.

### SUMMARY

Generally, this disclosure enables various computing technologies for predicting various personality traits from various facial and cranial images of persons and then acting accordingly. For example, there can be a system that is programmed to predict a number of defined personality traits, based primarily on facial and cranial images of a person. The system can be programmed to predict a series of expected behaviors from various relationships between various personality traits. The system can be programmed to perform a personality analysis based on a defined psychological model, where the personality analysis can comprise personality traits, expected behaviors and personality profiling. The system can be programmed to establish similarities and differences in relation to personality traits and behaviors expected of various individuals. The system can be programmed to employ computer vision, image processing (static and dynamic), machine learning, and cloud computing to perform such processes. The system can be programmed to provide, as an output, a personality assessment report to a user via a network (e.g., LAN, WAN, cellular network, satellite network, fiber-optic network, wired network, wireless network). The system can be programmed to cause display of a result of a personality analysis in different ways to the user (e.g., mobile app, browser, email attachment, OTT, texting, social networking service).

Some embodiments can include a computing technique to computationally predict various personality traits from facial and cranial images of a person. The technique can include capturing images or videos of the person from various image capture devices (e.g., cameras). The image capture devices can be online or offline. The image capture devices can include a camera of a smartphone, a tablet, a laptop, a webcam, a head-mounted frame, a surveillance camera, or a wearable. The image capture devices can capture the images or the videos offline and then upload for later analysis by a computing system, as described herein. The computing system can be programmed to obtain (e.g., download, manual user input) additional information about the person (e.g., race, age, gender, nationality, email, etc.) provided by that same person or estimated by a third party user. The computing system can be programmed to send such information through network (e.g., LAN, WAN, cellular network, satellite network, fiber-optic network, wired network, wireless network) for local or remote storage and further local or remote processing. The computing system can be programmed for processing, encryption of any information received, both images and any other additional information. The computing system can include a database (e.g., relational, non-relational, NoSQL, graphical, in-memory) and be programmed to generate a user profile and its associated metadata and then store the user profile in the database. The computing system can be programmed to obtain master images (e.g., front, profile, semi-profile) from various images of the person, as input from the image capture devices. The computing system can be programmed to standardize the master images (e.g., size, saturation, contrast, resolution, color filter, 90° rotation, mirror, pose). The computing system can be programmed to analyze various images, as input from the image capture devices, for face detection (e.g., based on eye detection, nose detection) of the person. The computing system can be programmed to obtain various facial landmarks of the person and position or locate the facial landmarks of the person in the master images. The computing system can be programmed to obtain various measures, relations, ratios, and angles between the facial landmarks of the person according to various defined specifications. The computing system can be programmed to process the various measures, relations, ratios, angles and user additional metadata of the person within a personality algorithm to predict various personality traits of the person, expected personality behavior of the person, and personality profile of the person. The computing system can be programmed to classify the person in defined profiles based on the personality traits and behaviors analyzed.

Some embodiments can include the computing system communicating with a robot (e.g., mobile robot, industrial or manipulator robot, service robot, education or interactive robot, collaborative robot, humanoid) or the robot including the computing system, where the robot is thereby programmed to adapt or control a physical world response of the robot to the person. This can be used to control, connect, or disconnect certain sensors or actuators or motors or valves or provoke certain behaviors of the robot based on the personality of the human the robot is interacting with.

Some embodiments can include the computing system being programmed to compare personality, traits behaviors and profiles of several persons based on various information extracted and processed from their respective images and metadata.

Some embodiments can include the computing system being programmed to generate a real-time personality analysis. This can happen in various scenarios. For example, during a video conference call, during an in-person interview, when a customer gets into a commerce establishment, or others.

Some embodiments can include the computing system being programmed to consolidate, at macro level, various personality traits, expected behaviors and profiles of analyzed population to extract macro trends as per defined criteria (e.g., country, race, age, gender).

Some embodiments can include the computing system being programmed to draw human identikits based on given personality traits, expected behaviors and profiles of a person.

Some embodiments can include the computing system being programmed to prediction predominant personality traits correspondent to various standard personality models (5G).

Some embodiments can include the computing system being programmed to communicably interface with or be included in a human resources software application (e.g. Gusto, Sage, Rippling, Bamboo) to select or discard candidates to a position based on various personality traits analyzed and various required personality traits and/or skills for the position, propose a team based on personality traits and skills for the position.

Some embodiments can include the computing system being programmed to communicably interface with or be included in a retail or point-of-sale software application, where retail or point-of-sale software application can generate a personality profile of a buyer and be able to advise a selling strategy and or be able to recommend a good or a service based on personality traits or tailor a customer experience in a retail environment.

### DESCRIPTION OF FIGURES

FIG. 1 is a schematic view of an embodiment of an end-to-end remote system to capture and process images and provide personality output to a user according to this disclosure.

FIG. 2 is a schematic view of an embodiment of a front end client module to retrieve user information remotely according to this disclosure.

FIG. 3 is a schematic view of an embodiment of a server module according to this disclosure.

FIG. 4 schematically illustrates an image gathering module according to this disclosure.

FIG. 5 schematically illustrates an output of a landmark detection module with various key landmarks detected in facial images according to this disclosure.

FIG. 6 schematically illustrates an output of a landmark measurement module with various relationships between different facial landmarks according to this disclosure.

FIG. 7 schematically illustrates an output of a landmark measurement module with various measurements, its description and values measured according to this disclosure.

FIG. 8 schematically illustrates a process of associating a personality trait to various facial traits according to this disclosure.

FIG. 9 schematically illustrates various master standard pictures used for personality prediction according to this disclosure.

FIG. 10 schematically illustrates various parent and secondary personality objects according to this disclosure.

FIG. 11 schematically illustrates some parent and secondary personality traits defined which constitute various system objects according to this disclosure.

FIG. 12 schematically shows an example of created system objects for a personality trait “General Personality” according to this disclosure.

FIG. 13 schematically illustrates a logic of a personality prediction module according to this disclosure.

FIG. 14 shows a schematic view of an end-to-end remote system in which a robot uses an automated personality computing system to adapt its behavior in front of a human he is interacting with according to this disclosure.

FIG. 15 schematically shows a cognitive architecture of a robot according to this disclosure.

### DETAILED DESCRIPTION

This disclosure may be embodied in many different forms and should not be construed as necessarily being limited to only embodiments disclosed herein. Rather, these embodiments are provided so that this disclosure is thorough and complete, and fully conveys various concepts of this disclosure to skilled artisans.

Note that various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

Likewise, as used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Similarly, as used herein, various singular forms “a,” “an” and “the” are intended to include various plural forms as well, unless context clearly indicates otherwise. For example, a term “a” or “an” shall mean “one or more,” even though a phrase “one or more” is also used herein.

Moreover, terms “comprises,” “includes” or “comprising,” “including” when used in this specification, specify a presence of stated features, integers, steps, operations, elements, or components, but do not preclude a presence and/or addition of one or more other features, integers, steps, operations, elements, components, or groups thereof. Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

Additionally, although terms first, second, and others can be used herein to describe various elements, components, regions, layers, or sections, these elements, components, regions, layers, or sections should not necessarily be limited by such terms. Rather, these terms are used to distinguish one element, component, region, layer, or section from another element, component, region, layer, or section. As such, a first element, component, region, layer, or section discussed below could be termed a second element, component, region, layer, or section without departing from this disclosure.

Also, unless otherwise defined, all terms (including technical and scientific terms) used herein have the same meaning as commonly understood by one of ordinary skill in an art to which this disclosure belongs. As such, terms, such as those defined in commonly used dictionaries, should be interpreted as having a meaning that is consistent with their meaning in a context of a relevant art and should not be interpreted in an idealized or overly formal sense unless expressly so defined herein.

Hereby, all issued patents, published patent applications, and non-patent publications (including hyperlinked articles, web pages, and websites) that are mentioned in this disclosure are herein incorporated by reference in their entirety for ail purposes, to same extent as if each individual issued patent, published patent application, or non-patent publication were copied and pasted herein and specifically and individually indicated to be incorporated by reference if any disclosures are incorporated herein by reference and such disclosures conflict in part and/or in whole with the present disclosure, then to the extent of conflict, and/or broader disclosure, and/or broader definition of terms, the present disclosure controls. If such disclosures conflict in part and/or in whole with one another, then to the extent of conflict, the later-dated disclosure controls.

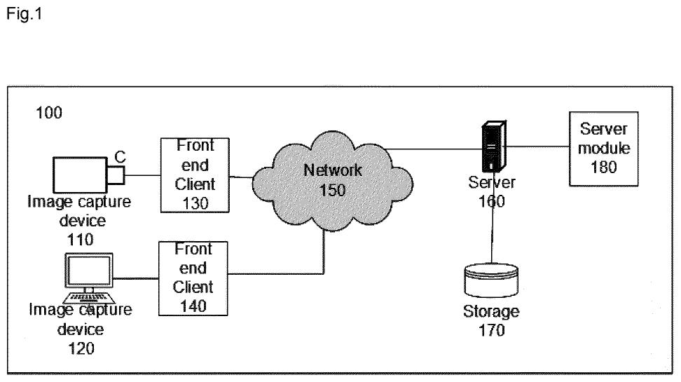

FIG. 1 is a schematic view of an embodiment of an end-to-end remote system to capture and process images and provide personality output to a user according to this disclosure. In particular, a topology 100 comprises client/s, server/s, data storage (including data storage controller), and camera/s. Some, many, most, or all components of the system, whether hardware or software, can be coupled directly or indirectly, whether in a wired or a wireless manner.

The topology 100 is based on a distributed network operation model which allocates tasks/workloads between servers, which provide a resource/service, and clients, which request the resource/service. The servers and the clients illustrate different computers/applications, but in some embodiments, the servers and the clients reside in or are one system/application. Further, in some embodiments, the topology 100 entails allocating a large number of resources to a small number of computers, such as the server 160, where complexity of the clients, such as the client's 110,120, depends on how much computation is offloaded to the small number of computers, i.e., more computation offloaded from the clients onto the servers leads to lighter clients, such as being more reliant on network sources and less reliant on local computing resources. Note that other computing models are possible as well. For example, such models can comprise decentralized computing, such as peer-to-peer (P2P) or distributed computing, such as via a computer cluster where a set of networked computers works together such that the computer can be viewed as a single system.

The network 150 includes a plurality of nodes, such as a collection of computers and/or other hardware interconnected via a plurality of communication channels, which allow for sharing of resources and/or information. Such interconnection can be direct and/or indirect. The network 150 can be wired and/or wireless. The network 150 can allow for communication over short and/or long distances, whether encrypted and/or unencrypted. The network 150 can operate via at least one network protocol, such as Ethernet, a Transmission Control Protocol (TCP)/Internet Protocol (IP)), and so forth. The network can have any scale, such as a personal area network (PAN), a local area network (LAN), a home area network, a storage area network (SAN), a campus area network, a backbone network, a metropolitan area network, a wide area network (WAN), an enterprise private network, a virtual private network (VPN), a virtual network, a satellite network, a computer cloud network, an internetwork, a cellular network, and so forth. The network 150 can be and/or include an intranet and/or an extranet. The network 150 can be and/or include Internet. The network 150 can include other networks and/or allow for communication with other networks, whether sub-networks and/or distinct networks, whether identical and/or different from the network in structure or operation. The network 150 can include hardware, such as a computer, a network interface card, a repeater, a hub, a bridge, a switch, an extender, an antenna, and/or a firewall, whether hardware based and/or software based. The network 150 can be operated, directly and/or indirectly, by and/or on behalf of one and/or more entities or actors, irrespective of any relation to contents of this disclosure.

The server 160 is and/or is hosted on, whether directly and/or indirectly, a server computer, whether stationary or mobile, such as a kiosk, a workstation, a vehicle, whether land, marine, or aerial, a desktop, a laptop, a tablet, a mobile phone, a mainframe, a supercomputer, a server farm, and so forth. The server computer can comprise another computer system and/or a cloud computing network. The server computer can run any type of operating system (OS), such as MacOS(R), Windows@, Android@, Unix@, Linux(R) and/or others. The server computer can include and/or be coupled to, whether directly and/or indirectly, an input device, such as a mouse, a keyboard, a camera, whether lot-ward-facing and/or back-facing, an accelerometer, a touchscreen, a biometric reader, a clicker, a microphone, or any other suitable input device. The server computer can include and/or be coupled to, whether directly and/or indirectly, an output device, such as a display, a speaker, a headphone, a printer, or any other suitable output device. In some embodiments, the input device and the output device can be embodied in one unit, such as a touch-enabled display, which can be haptic. The server computer can host, run, and/or be coupled to, whether directly and/or indirectly, a database, such as a relational database or a non-relational database, such as a post-relational database, an in-memory database, or others, which can feed, avail, or otherwise provide data to at least one of the server 160, whether directly and/or indirectly. The server 160 can be at least one of a network server, an application server, or a database server. The server 160, via the server computer, can be in communication with the network 150, such as directly and/or indirectly, selectively and/or unselectively, encrypted and/or unencrypted, wired and/or wireless. Such communication can be via a software application, a software module, a mobile app, a browser, a browser extension, an OS, and/or any combination thereof. For example, such communication can be via a common framework/application programming interface (API), such as Hypertext Transport Protocol Secure (HTTPS).

The server 160 communicably interfaces with a server module 180. The server module 180 which is remote to the server 160, but can be local to the server 160. The server module 180 creates a user record in the storage 170.

At least one or the client's 130,140 can be hardware based and/or software-based. At least one or the clients 130,140 is and/or is hosted on, whether directly and/or indirectly, a client computer, whether stationary or mobile, such as a terminal, a kiosk, a workstation, a vehicle, whether land, marine, or aerial, a desktop, a laptop, a tablet, a mobile phone, a mainframe, a supercomputer, a server farm, and so forth. The client computer can comprise another computer system and/or cloud computing network. The client computer can run any type of OS, such as MacOS@, Windows@, Android(R), Unix(R), Linux(R) and/or others. The client computer can include and/or be coupled to an input device, such as a mouse, a keyboard, a camera, a touchscreen, a biometric reader, a clicker, a microphone, or any other suitable input device. The client computer can include and/or be coupled to an output device, such as a display, a speaker, a headphone, a joystick, a vibrator, a printer, or any other suitable output device. In some embodiments, the input device and the output device can be embodied in one unit, such as a touch-enabled display, which can be haptic. The client computer can include circuitry, such as a receiver chip, for geolocation/global positioning determination, such as via a GPS, a signal triangulation system, and so forth. The client computer can host, run and/or be coupled to, whether directly and/or indirectly, a database, such as a relational database or a non-relational database, such as a post-relational database, an in-memory database, or others, which can feed or otherwise provide data to at least one of the client's 110, 120, whether directly and/or indirectly.

At least one of the clients 130,140 is in communication with network, such as directly and/or indirectly, selectively and/or unselectively, encrypted and/or unencrypted, wired and/or wireless, via contact and/or contactless. Such communication can be via a software application, a software module, a mobile app, a browser, a browser extension, an OS, and/or any combination thereof. For example, such communication can be via a common framework/API, such as HTTPS. In some embodiments, the server 160 and at least one of the client's 130,140 can also directly communicate with each other, such as when hosted in one system or when in local proximity to each other, such as via a short range wireless communication protocol, such as infrared or Bluetooth. Such direct communication can be selective and/or unselective, encrypted and/or unencrypted, wired and/or wireless, via contact and/ or contactless. Since many of the client's 130,140 can initiate sessions with the server 160 relatively simultaneously, in some embodiments, the server 160 employs load balancing technologies and/or failover technologies for operational efficiency, continuity, and/or redundancy.

The storage controller 170 can comprise a device which manages a disk drive or other storage, such as flash storage, and presents the disk drive as a logical unit for subsequent access, such as various data input/output operations, including reading, writing, editing, deleting, updating, searching, selecting, merging, sorting, or others. The storage controller 170 can include a front-end side interface to interface with a host adapter of a server and a back-end side interface to interface with a controlled disk storage. The front-end side interface and the back-end side interface can use a common protocol or different protocols. Also, the storage controller 170 can comprise a physically independent enclosure, such as a disk array or a storage area network or a network attached storage server. For example, the storage controller 170 can comprise a redundant array or independent disks (RAID) controller. In some embodiments, the storage controller 170 can be lacking such that a storage can be directly accessed by the server 160. In some embodiments, the controller 170 can be unitary with the server 160.

The storage 170 can comprise a storage medium, such as at least one of a data structure, a data repository or a data store. For example, the storage medium comprises a database, such as a relational database, a non-relational database, an in-memory database, or others, which can store data and allow access to such data to the storage controller 170, whether directly and/or indirectly, whether in a raw state, a formatted state, an organized stated, or any other accessible slate. For example, the data can comprise image data, sound data, alphanumeric data, or any other data. For example, the storage 170 can comprise a database server. The storage 170 can comprise any type of storage, such as primary storage, secondary storage, tertiary storage, online storage, volatile storage, non-volatile storage, semiconductor or storage, magnetic storage, optical storage, flash storage, hard disk drive storage, floppy disk drive, magnetic tape, or other data storage medium. The storage 170 is configured for various data I/O operations, including reading, writing, editing, modifying, deleting, updating, searching, selecting, merging, sorting, encrypting, de-duplicating, or others. In some embodiments, the storage 170 can be unitary with the storage controller. In some embodiments, the storage 170 can be unitary with the server 160.

An image capture device 110, 120 comprises an optical instrument for capturing and recording images, which may be stored locally, transmitted to another location, or both. For example, the image capture device 110, 120 can include an optical camera. The images may be individual still photographs or sequences of images constituting videos. The images can be analog or digital. The image capture device 110, 120 can comprise any type of lens, such as convex, concave, fisheye, or others. The image capture device 110, 120 can comprise any focal length, such as wide angle or standard. The image capture device 110, 120 can comprise a flash illumination output device. The image capture device 110, 120 can comprise an infrared illumination output device. The image capture device 110, 120 is powered via mains electricity, such as via a power cable or a data cable. In some embodiments, the image capture device 110, 120 is powered via at least one of an onboard rechargeable battery, such as a lithiumion battery, or an onboard renewable energy source, such as a photovoltaic cell, a wind turbine, or a hydropower turbine. The image capture device 110, 120 is coupled to the client's 130, 140, whether directly or indirectly, whether in a wired or wireless manner. The image capture device 110, 120 can be configured for geotagging, such as via modifying an image file with geolocation/coordinates data. The image capture device 110, 120 can be front or rear facing, if the client/s 130, 140 is a mobile device, such as a smartphone, a tablet, ora laptop. The image capture device 110, 120 can include or be coupled to a microphone. The image capture device 110, 120 can be a pan-tilt-zoom camera.

In one mode of operation, the image capture device 110, 120 sends a captured image to the client 130 which then sends the image to the server 160 over the network 150. The server 160 stores the image in the storage 170 via the storage controller. The second client 140 can comprise a manager terminal in signal communication with the server 160 over the network 150 to manage the server 160 over the network 150. The manager terminal can comprise a plurality or input/output devices, such as a keyboard, a mouse, a speaker, a display, a printer, a camera, or others, with the manager terminal being embodied as a tablet computer, a laptop computer, or a workstation computer, where the display can output a graphical user interface (GUI) configured to input or to output information, whether alphanumerical, symbolical, or graphical, to a manager operating the manager terminal. The input can include various management information for managing the server 160 and the output can include a status of the server 160, the storage controller, or the storage 170. The manager terminal can be configured to communicate with other components or the topology over the network for management or maintenance purposes, such as to program, update, modify, or adjust any server, controller, computer, or storage in the topology. The GUI can also be configured to present other management or non-management information as well.

Note that any computing device as described herein comprises at least a processing unit and a memory unit operably coupled to the processing unit. The processing unit comprises a hardware processor, such as a single core or a multicore processor. For example, the processing unit comprises a central processing unit (CPU), which can comprise a plurality of cores for parallel/concurrent independent processing. The memory unit comprises a computer-readable storage medium, which can be non-transitory. The storage medium stores a plurality of computer-readable instructions for execution via the processing unit. The instructions instruct the processing unit to facilitate performance of a method for recognizing a symbol in an image, as disclosed herein. For example, the processing unit and the memory unit can enable various file or data input/output operations, including reading, writing, editing, modifying, deleting, updating, searching, selecting, merging, sorting, encrypting, de-duplicating, or others. The memory unit can comprise at least one of a volatile memory unit, such as random access memory (RAM) unit, or a non-volatile memory unit, such as an electrically addressed memory unit or a mechanically addressed memory unit. For example, the electrically addressed memory comprises a flash memory unit. For example, the mechanically addressed memory unit comprises a hard disk drive. The memory unit can comprise a storage medium, such as at least one of a data repository, a data mart, or a data store. For example, the storage medium can comprise a database, such as a relational database, a non-relational database, an in-memory database, or other suitable databases, which can store data and allow access to such data via a storage controller, whether directly and/or indirectly, whether in a raw state, a formatted state, and an organized stated, or any other accessible state. The memory unit can comprise any type of storage, such as a primary storage, a secondary storage, a tertiary storage, an off-line storage, a volatile storage, a non-volatile storage, a semiconductor storage, a magnetic storage, an optical storage, a flash storage, a hard disk drive storage, a floppy disk drive, a magnetic tape, or other suitable data storage medium.

Whether additionally or alternatively, there can also be a self-executing software module, analog to any local software executed locally in a stand-alone computer. This self-executing module would be stored locally in any unit with information processing capacity, such as a personal computer, a laptop, a tablet, a mobile phone, a wearable, and that integrates an ability to capture images. In this case, various operations described herein would integrate various functions described in this document in the self-executing file, in a similar way that some software programs are executed locally.

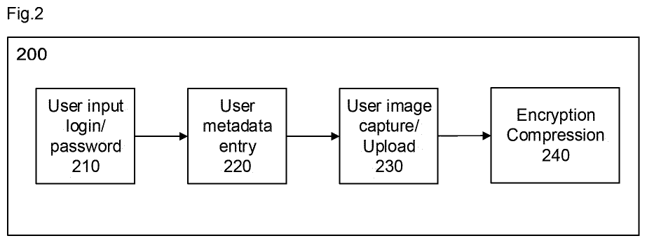

FIG. 2 is a schematic view of an embodiment of a front end client module to retrieve user information remotely according to this disclosure. In particular, a front end client module 200 is software module programmed (e.g., Python, Java) to capture user information remotely. The front end client module 200 can be embodied within clients 130, and 140. The front end client software module 200 can be allocated in a variety of devices, mobile phone, smartphone, tablet, laptop, wearable, or personal computer. The front end module 200 establishes a bidirectional communication path with the server/s (160) and data storage/s (170).

As described herein, a user information object comprises images either static (pictures) or dynamic (videos) and other metadata, such as name, email, age, gender, race, nationality, or others. The module 200 is programmed to gather the user information object from a user including login and password 210; metadata 220, and images 230, as selected or uploaded by the user or by 3^{rd} party user. The module 200 is programmed to perform encryption and compression function 240 and sends the user object information as encrypted and compressed to the server 160 through the network 150. When the user information object is received in the server 160 and the server module 180 creates the user record in the storage 170. For example, the user record can be a database record with various data fields.

The encryption and compression function 240 encrypts the user information object and prepares the user information object to be transported through the network 150 (encryption at application level). Data encryption module can be done using Advanced Encryption Standard (AES) 128, 192, 256 bit blocks as well as other state of the art standard algorithms such as Blockchain, FIPS compliant cryptographic algorithms, or biometric data encryption protocols available. At transport layer level, the encryption and compression function 240 can as well include compression of the data using state of the art encryption methods (e.g., SSL, TLS, PGP or S/MIME, IPSec or SSH tunneling).

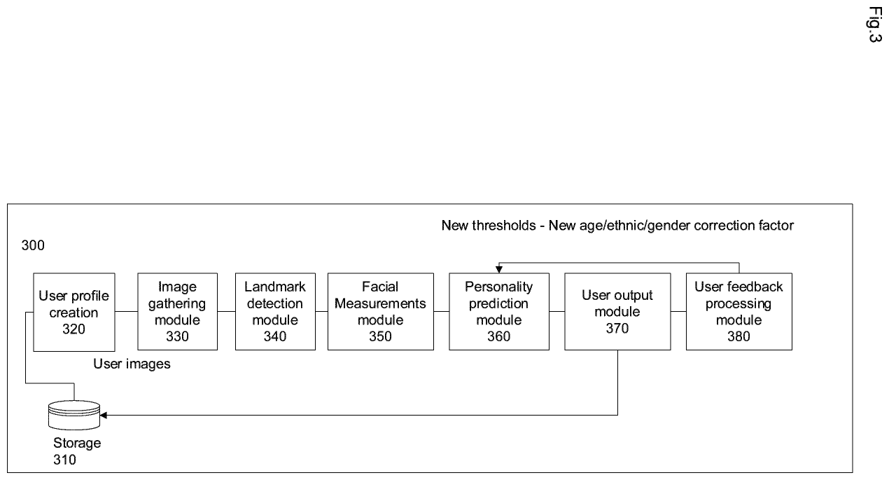

FIG. 3 is a schematic view of an embodiment of a server module according to this disclosure. In particular, a server module 300 can correspond to the server module 180 of FIG. 1. The server module 300 include modules 320-380.

The user profile creation module 320 receives the information from the network (150) sent by the front end client (130,140). The information is encrypted at application layer, and the user profile creation module 320 decrypts and decompress the information, creating a new user in the storage system (370). In case the user is already created or the information is invalid, the user profile creation module 320 will advise the user.

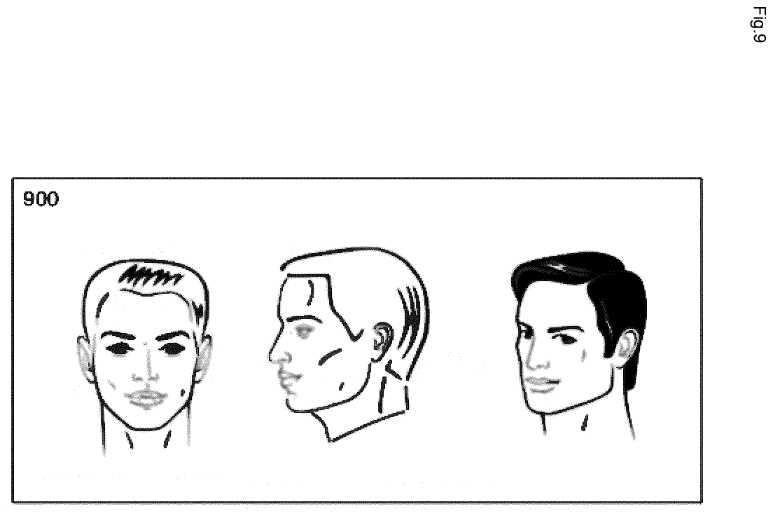

The Image gathering module 330, image gathering module, is a module which retrieves the metadata of the user to be analyzed retrieving the images (pictures and/or videos) and obtaining master standardized pictures from the subject (FIG. 9, 900). These master standard pictures are the input for the subsequent modules of the system. The master standard pictures as neutral pose, frontal, profile and semi-profile pictures FIG. 9, 900.

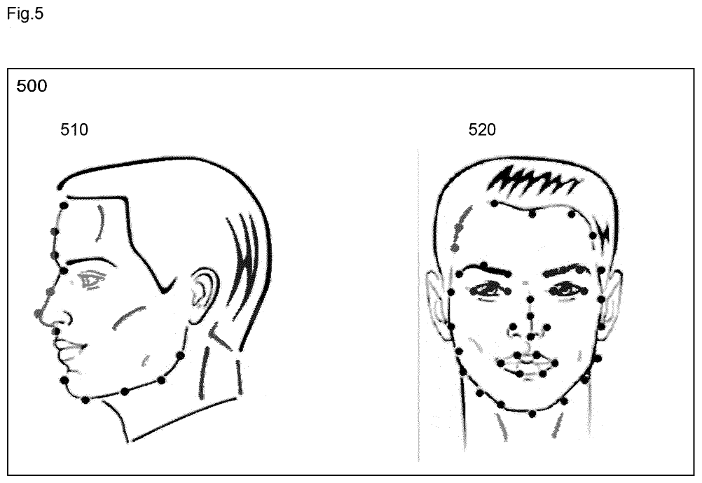

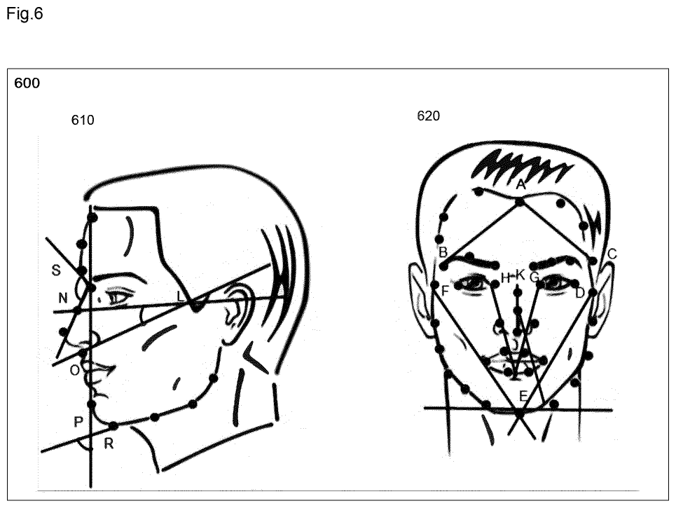

The master standard pictures (900) are an input of module 340, landmark detection module. The landmark detection module defines a number of landmarks positioned on the master standard pictures of the user. These landmarks have been determined based on a scientific research carried out based on this disclosure, such as landmarks A, B, C, J shown in FIG. 6 in diagrams 610 and 620. The module 340 uses various computer vision algorithms to locate on the master images the defined points corresponding to the landmarks. In some embodiments, there may be a learning module, by which an artificial intelligence algorithm, such as Scale Invariant Feature Transform (SIFT) (Karami E, Shehata M, Smith A (2017) Image Identification Using SIFT Algorithm: Performance Analysis against Different Image Deformation); Speeded Up Robust Features (SURF) (Bay H, Tuytelaars T, Van Cool L (2006) SURF: Speeded Up Robust Features. Springer, Berlin, Heidelberg, pp 404-417); Features from Accelerated Segment Test (FAST) (Rosten E, Drummond T (2006) Machine Learning for High-Speed Corner Detection. Springer, Berlin, Heidelberg, pp 430-443); Hough transforms (Goldenshluger A, Zeevi A (2004) The Hough Transform Estimator. 32:. https://doi.org/10.1214/009053604000000760); Geometric hashing (Tsai FCD (1994) Geometric hashing with line features. Pattern Recognit 27:377-389. https://doi.org/10.1016/0031-3203(94)90115-5); or Support Vector Machines (SNV) (Cortes, Corinna and Vapnik, Vladimir, N. “Support-Vector Networks”, Machine Learning, 20, 1995), each of which is incorporated by reference herein for all purposes, is trained in order to correctly position some landmarks on the face of the person. For example, an outcome of the landmark detection module 340 is represented in FIG. 5 (510 and 520).

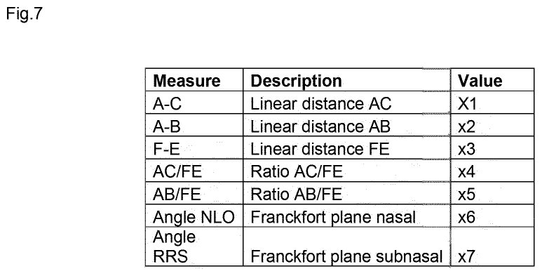

The landmark measurements module 350 receives as input the master standard pictures (510,520) with the defined landmarks positioned in the face of the individuals. In some cases, the landmark measurements module 350 will be required to apply manual corrections in case the landmarks that are not exactly positioned. Additionally, some other facial features may be as well required to be input, automatically or manually to ensure the personality assessment is accurate. The landmarks measurement module 350 calculates distances, ratios, values, angles, proportions, deviations, thresholds and so forth taking as an input the different landmarks identified (510, 520), its position and the relationship between values defined as per the scientific research, as noted above. As further described below, FIG. 6 shows an example of the landmarks positioned in the master standard images and the relationships between them that are subject of measurement of the landmark measurement module 350. An example of an output of the landmark measurements module 350 is shown in FIG. 7 depicting in an example output table with the measure and its measured or calculated value. The output of the landmarks measurement module (as shown in FIG. 7) is an input of the personality prediction module 360.

The personality prediction module 360 is the module that given the facial measures, ratios, values, angles and so forth output of the measurements module 350, and given the user additional metadata, predicts the different personality traits of the individual, expected behaviors and classifies the individual in defined profiles based on the personality traits and behaviors analyzed. The personality prediction module 360 can also incorporate or perform other functionality, such as (1) comparison of personality, traits behaviors and profiles of several individuals based on the information extracted and processed from their respective images and metadata, (2) real-time personality analysis for use during a video conference call, during an interview, when a customer gets into a commerce, (3) consolidation at macro level, personality traits, expected behaviors and profiles of analyzed population to extract macro trends as per defined criteria (country, race, age, gender), (4) draw human identikits based on given personality traits, expected behaviors and profiles of a subject, (5) predict predominant personality traits correspondent to other standard personality models (5G).

The customer output module 370 transforms the results of the analysis performed by the personality prediction module 360 into a format suitable to be presented to the user. Analysis output can be in concise text, as list of traits with magnitude, or a detailed report with detailed descriptions of the traits, its definitions and the values for the individual for which the assessment has been performed. The output style can be tailored according to the reader's personality (e.g., a sensitive person, one with sense of humor). The output style can be displayed in any kind of format or sent by email or any other communication mean to the front end client. It can be a printed output, or a digital output.

The user may be asked to provide feedback on the analysis provided, which is enabled by the user feedback module 380. This feedback is processed using statistical analysis and may give as result a variation in some ratios used by the personality prediction module 360 for the correspondent personality trait.

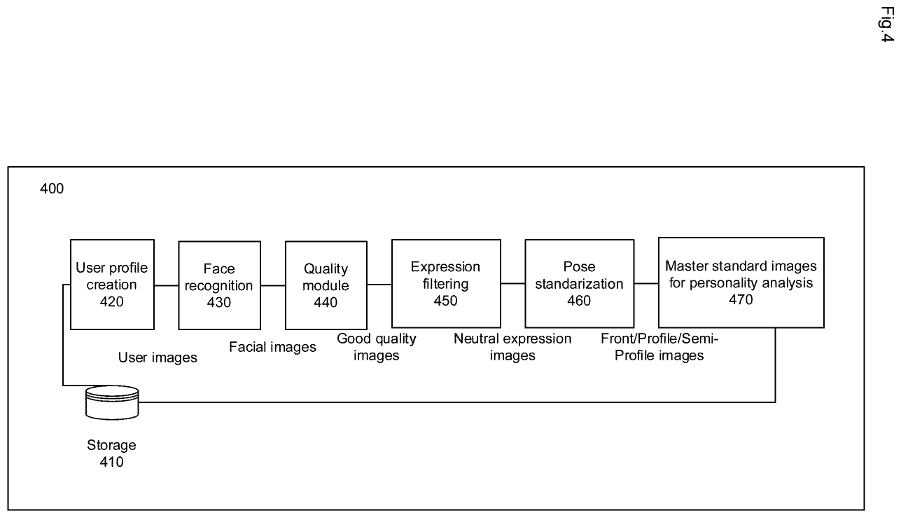

FIG. 4 schematically illustrates an image gathering module according to this disclosure. In particular, various images may be obtained from different sources, such as social networks. These images can have a neutral pose and front, profile and semiprofile view of the individual as shown in FIG. 9. As shown in FIG. 4, the images (static or videos) are received from different data sources and a logic is applied to obtain master standard images, as shown in FIG. 9 which is suitable for analysis, as described herein. For example, an automated process selects only appropriate images from the search results, where a face recognition module 430 may be used to ensure that all selected images depict the same face.

A face quality module 440 uses various quality metrics, such as face size, face shape, and face image sharpness to select face select images of good quality. Other measures may include face visibility or level of occlusion, such as from glasses or hair style. Such analysis can be implemented by using techniques such as disclosed by Y. Wong et al., Patch based Probabilistic Image Quality Assessment for Face Selection and Improved Video-based Face Recognition, CVPR 2011, which is incorporated by reference herein for all purposes. The face quality module can use the landmark detection process using the number or detectable landmarks as a face quality metric as well as for pose detection and subsequent alignment.

A face expression analysis module 450 further selects various face images or neutral expression, in order to avoid biased results or face personality analysis due to extreme expressions. Such expression analysis can be implemented by using techniques such as disclosed by B. Fasel and J. Luettin, Automatic Facial Expression Analysis: A Survey (1999), Pattern Recognition, 36, pp. 259-275, 1999, which are incorporated by reference herein for all purposes. A pose standardization module 460 selects and classifies images of the preferred full frontal or side profile pose.

When the source of face images is a video image sequence, then various steps performed by the quality filtering module 440, the expression filtering module 450 and the pose filtering module 460 are conducted on multiple images from the sequence to select good images. Still, the selected images may be highly redundant, as if sequence dynamics are slow. In such a case, key-frame selection method may be used to reduce the number of face images. Alternatively, one can use face similarity metrics to detect redundancy and select a reduced number of representative face images.

When multiple images of same person are suitable for analysis, such multiple images can be combined to increase the accuracy of said analysis. As one example of combining multiple images, the images are analyzed independently, producing a set of trait values for each image. Then a statistical process such as majority voting or other smoothing or filtering process is applied to produce a robust statistical estimate of said trait value.

A master standard images for personality analysis module 470 is a module that obtains a set of pictures after the set of pictures was processed through the previous modules described before (420-460) so that the personality analysis can be performed. The set of pictures includes master standard pictures that are comprised by minimum of 3 static pictures (front, profile and semi-profile), with correct lightning conditions, head in upright position and neutral background. An example of the master standard pictures can be found in FIG. 9. Having the master standard pictures of good quality ensures that the subsequent analysis will be sufficient.

FIG. 5 schematically illustrates an output of a landmark detection module (340) with various key landmarks detected in facial images according to this disclosure. In particular, as previously described in context of FIG. 3, the output of the module landmark detection module 340 is schematically shown in FIG. 5, where the key landmarks defined have been positioned in the facial pictures of the individual object of the analysis. The picture exemplifies how each landmark is given a positon in the image resulting in a set of coordinates. These values will be later on be used in the facial measurements module 350 in order to obtain the different facial measurements.

FIG. 6 schematically illustrates an output of a facial measurement module 350 with various relationships between different facial landmarks according to this disclosure. In particular, as previously described in context of FIG. 3, the output of the module Landmark detection module (340) gives as a result a set of landmarks positioned in the facial picture of the individual as explained in context of FIG. 5. As previously described, the landmarks measurement module 350 calculates distances, ratios, values, angles, proportions, deviations, thresholds, and so forth.

FIG. 7 schematically illustrates an output of a landmark measurement module 350 with various measurements, its description and values measured according to this disclosure. In particular, where FIG. 6 represented the graphical relationship between the identified landmarks, FIG. 7 shows the measurements obtained after the facial measurements module 350 is applied as described in context of FIG. 3.

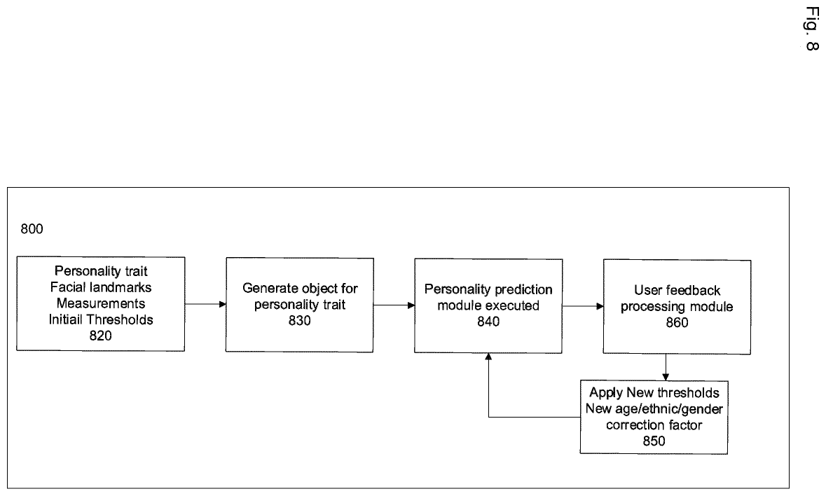

FIG. 8 schematically illustrates a process of associating a personality trait to various facial traits according to this disclosure. In particular, a personality model defines various personality traits, as known in psychology. Therefore, FIG. 8 shows a course of action from an offline research technique 810 to a personality prediction module 840, which automatically predicts personality traits. The offline research technique 810 includes various components.

First, there is a bibliographic research and an establishment of a qualitative model of personality. This includes the bibliographic compilation of articles, research, books, documents, or other non-transitory mediums in the field of medicine, biology, neuroscience, psychology, dentistry, anthropology and other areas of knowledge that establish some kind of direct or indirect relationship between the biology of the individual and potential personality traits. Some of the bibliographic sources, each of which is incorporated by reference herein for all purposes, consulted have been, Robert Sapolsky: Behave. Vintage. Peguin Random house; Ekman, Paul, “Universal and cultural differences in facial expressions of emotion”. I. J. Cole. (Ed.); Mclean, P. D “The triune brain in evolution Role in paleodebral functions”, NY, Plenum.; De Meyer, “Median facial malformations and their implications for brain malformations. Birth defects. 1975: XI: 155-181; Rita Carter, “The brain book”, DK. John, Oliver, “Handbook of Personality” Ed. Guilford. Rob Ranyard, “Decision making, cognitive models and explanations”, Ed. Routledge. Further, the establishment of the quantitative personality model includes an establishment of a first version of the psychological model based on a series of assumptions and working hypotheses. In this model, there is an identification of a series of facial features and measurements and an assumption of a series of hypotheses by which these physical features are related, as well as the maximum values for a series of personality features.

Second, there is a validation of the quantitative personality model. The validation includes a repeated validation of said model with a group of users, from which certain hypotheses are discarded, others are established and the initial assumptions regarding facial features and facial features are modified and associated personality.

Third, there is an establishment of various parameters and relationships and algorithms that allow coding the facial features associated with personality traits, the reference values, as well as the relationships established between the different facial features in relation to the different personality traits of holistic way.

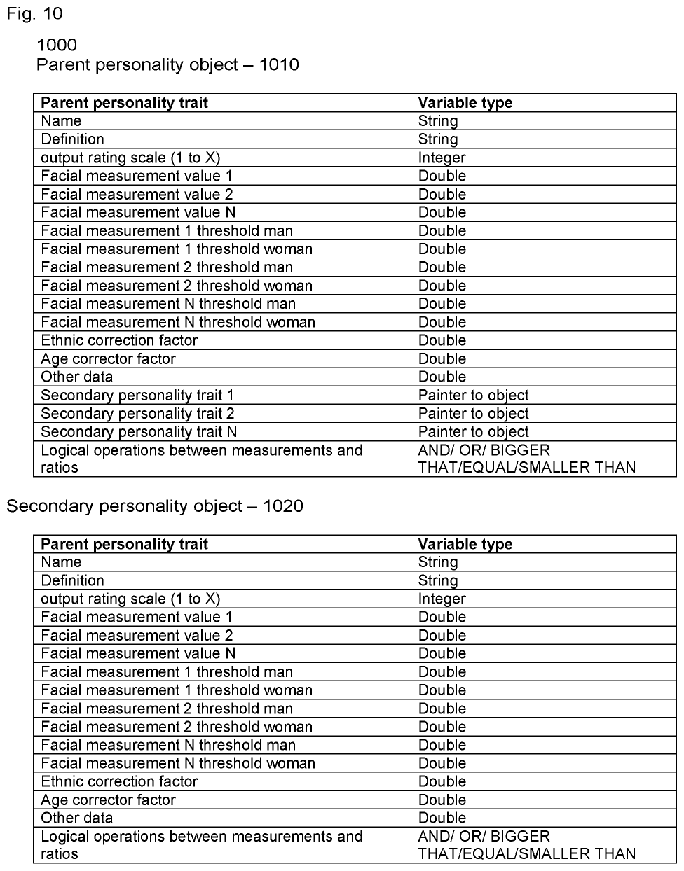

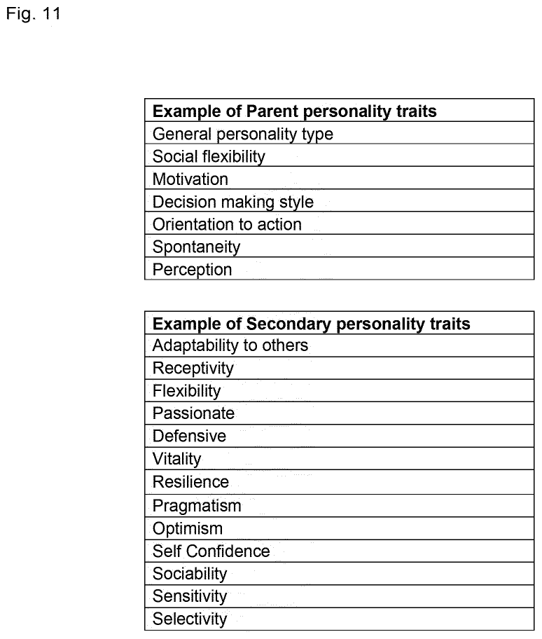

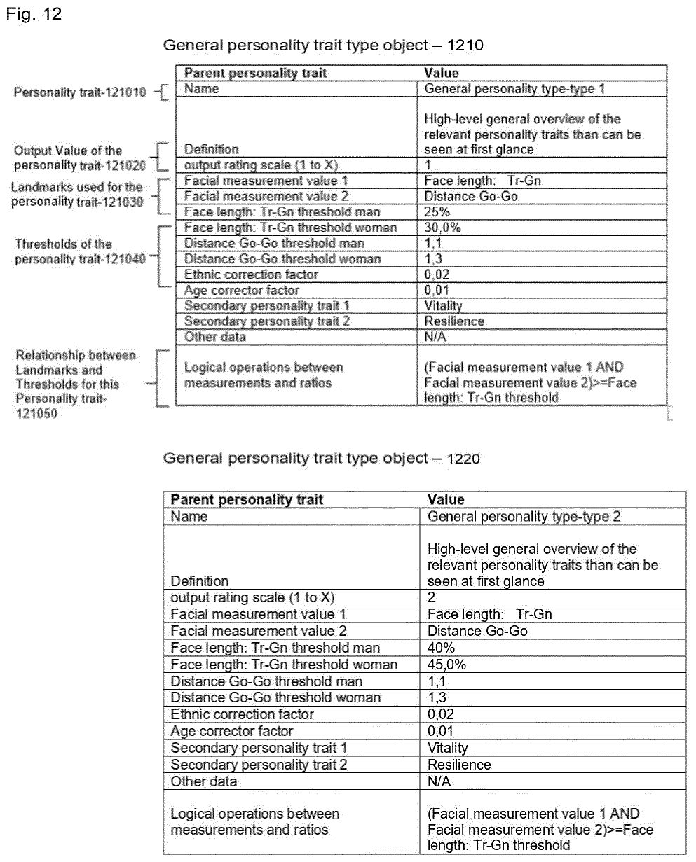

Personality traits, facial traits and measurements as well as age, gender, ethic and other initial ratios are determined out of the offline research technique 810, as described herein. Each personality trait can be defined by a number of parameters, which can be coded into the server 160 during step 830. The personality traits can be coded into objects in various ways. For example, these objects can themselves contain all the relevant information about the personality trait. An example of how these objects are structured and the variables they contain can be found in FIG. 10 where an object 1010 contains a generic example of all information related to a main personality trait and an object 1020 contains all information related to a secondary personality trait. The parameters referred in this section are the different constants and variables defined in the objects as shown in FIG. 10. Note that FIG. 11 shows an example of the main and secondary personality traits defined. These personality traits are then implemented into objects as shown in FIG. 12. Likewise, FIG. 12 represents an example of how the personality trait “General personality” would be coded in the system and its parameters associated and the values associated to this concrete personality trait.

FIG. 9 schematically illustrates various master standard pictures used for personality prediction according to this disclosure. In particular, the master standard pictures can be pictures that are the outcome of the process explained in context of FIG. 4. The initial pictures of the individuals may have been taken in multiple conditions of light, color, saturation, skew, pose, or others. As explained in context of FIG. 4, the pictures initially provided are processed in the face recognition module 430. This module ensures that some, many, most, or all images provided depict the same face. Then, the face quality module 440 uses various quality metrics, such as face size, face shape, face image sharpness, or others, to select face images of good quality. The pictures output of this quality module 440 are then going through the face expression analysis module 450, which further selects various face images or neutral expression, in order to avoid biased results or face personality analysis due to extreme expressions. Then, the pictures output from the module 450 are input into the pose standardization module 460. The pose standardization module 460 selects and classifies images of the preferred full frontal or side profile pose. The output images obtained after this process can be the master standard pictures.

FIG. 10 schematically illustrates various parent and secondary personality objects according to this disclosure. In particular, there can be two types of objects, parent personality traits and secondary personality traits. Each parent and secondary personality trait can be represented in as an object containing metadata, such as trait name, trait definition, trait output rating, facial measurements associated to that particular trait for men and women, ethnic factor correction, age factor correction, thresholds associated to each facial measurement, the secondary personality traits associated to the parent and the logical relationships that facial measurements and thresholds have to meet.

FIG. 11 schematically illustrates some parent and secondary personality traits defined which constitute various system objects according to this disclosure. In particular, there is shown an example of the primary (1110) and secondary personality traits (1111).

FIG. 12 schematically shows an example of created system objects for a personality trait “General Personality” according to this disclosure. In particular, various objects are stored in the storage 170 for one of the personality traits determined, so called General personality profile, which are indexed as 1210, 1220. Analog objects would be created and stored in the storage 170 for each of the personality traits (e.g., impulsivity, orientation to action). The personality prediction module 840 uses these objects to predict a personality output to the user (e.g., customer). For example, a customer will be asked to provide feedback on an output given. This feedback will be statistically analyzed in the user feedback processing module 860 and personality objects will be enhanced accordingly by a module 850 by modifying thresholds, correction factors as well as the logical operations between measurements and ratios.

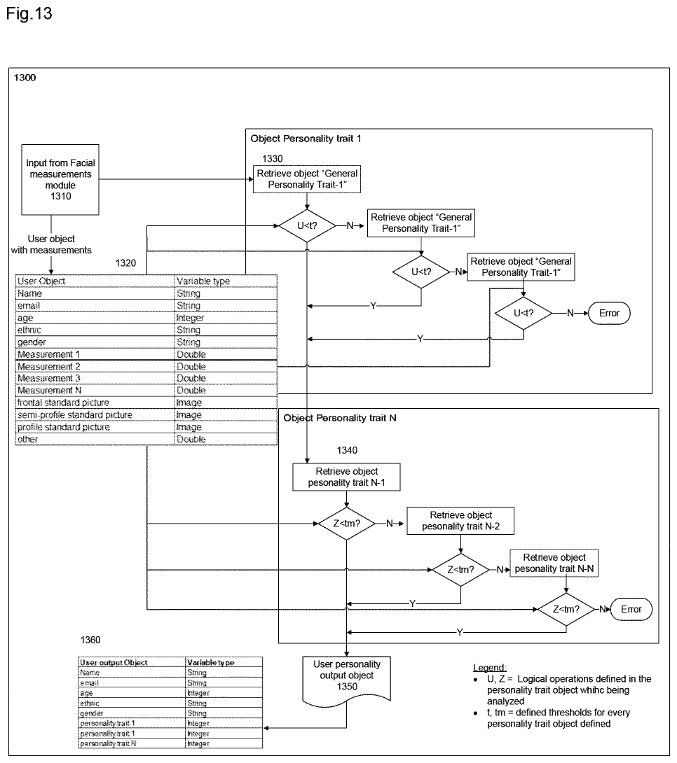

FIG. 13 schematically illustrates a logic of a personality prediction module according to this disclosure. In particular, a logic 1300 has a facial measurement module 1310 produces a series of measurements, ratios, angles and so forth (e.g., values generated by modules 820, 830) as exemplary shown in FIG. 7 which are stored in a user object 1320. The user object 1320 is then used as an input of the personality prediction module 840. There will be a sequential retrieval 1330 of personality traits objects (1 to N). The retrieval 1330 can use reference measurements, thresholds, correction factors, logical operations between measurements and secondary personality references. The logic 1300 will apply various logical operations (e.g., Boolean) defined in the user object 1320 comparing accordingly various user measurements from the user object 1320 against various thresholds for the given trait. This comparison for a given trait will continue until there is a match for the personality trait value for the user or until an error state is reached, as determined via various preset criteria. When the error state reached, the logic 1300 will abort the analysis of the personality of the person and will indicate to the user that the analysis cannot be done. On the contrary, when there is a finding of the value of the personality trait for the user, then the logic 1300 will move to the next personality trait. For the next personality trait, the logic 1300 will repeat the same operation as described above. The sequence will finish when all personality objects have been analyzed as indexed by 1340. The logic 1300 will only retrieve those personality trait objects selected by user. For example, if the user wants to assess the impulsivity of the individual, only the software objects which describe this personality trait will be selected and executed by the logic 1300. The personality prediction module will generate a final User personality output object 1350 in which all the personality traits for the user will be informed (1360). As described herein, this information will be processed in the user output module (370) to produce a final output report for the customer or will be used as input in other automated system, for instance a personal care robot software module.

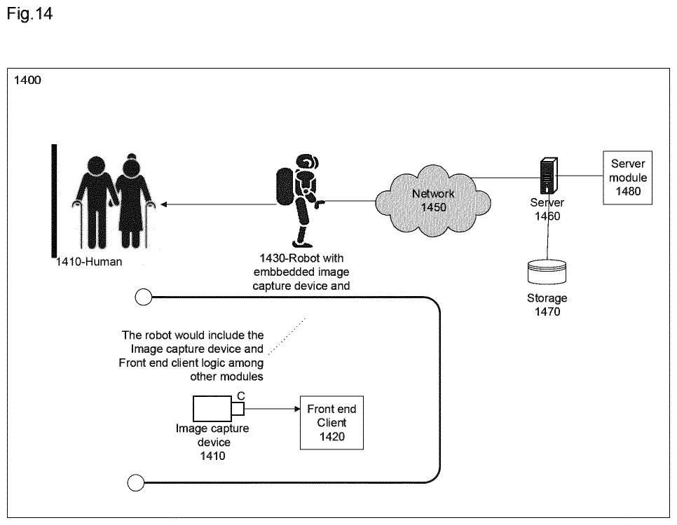

FIG. 14 shows a schematic view of an end-to-end remote system in which a robot uses an automated personality computing system to adapt its behavior in front of a human he is interacting with according to this disclosure. In particular, although many robots today are used in factories, technological advances are enabling specialized robots to automate many tasks in non-manufacturing industries, such as agriculture, construction, health care, retailing and other services. These so-called “field and service robots” aim at a fast growing service sector and promise to be a key product for the next decades. For example, a robot can be an autonomous machine capable of sensing its environment, carrying out computations to make decisions, and performing actions in the real world. For example, the robot can include mobile robot, industrial or manipulator robot, service robot, education or interactive robot, collaborative robot, or others. The robot can be classified depending on usage: entertainment, education, humanoids, or others. There are some type of robots as the ones mentioned above which are designed to interact with a human. For these robots to interact with humans, there may be a desire to provide them with a form of social intelligence. Thanks to improvement of their expressive and communication skills, robots are assuming an increasingly integrated role in society. There are several discussions about the abilities that robots can exhibit to be considered socially adaptive. The robots can be able to engage a social interaction with people, understand their intentions by recognizing social signs, express emotions and adapt their behavior to the different social situations. A proper cognitive architecture is needed to model these features. The success of a social interaction strongly depends on the ability to recognize and properly understand the intention of people. People intention can be inferred by processing the multi-modal signals conveying information about social actions, emotions, attitudes and relationships.

As described herein, a computing system can communicate with a robot (e.g., mobile robot, industrial or manipulator robot, service robot, education or interactive robot, collaborative robot) or the robot can include the computing system, where the robot is thereby programmed to adapt or control a physical world response of the robot to the person. This can be used to control, connect, or disconnect certain sensors or actuators or motors or valves or provoke certain behaviors of the robot based on the personality of the human the robot is interacting with.

As shown, FIG. 14 illustrates a schematic view of an embodiment of an end-to-end remote system to capture and process images and provide personality output to a user according to this disclosure. In particular, a topology 1400 comprises front-end client/s module/s 1420 and image capture device/s 1410 embedded in a head, torso, arm, leg, body, end effector, frame, or housing of one or more robot/s 1430, server/s 1460, or data storage (including data storage controller) 1470. Note that same considerations described above in context of FIG. 1 are applicable here as well.

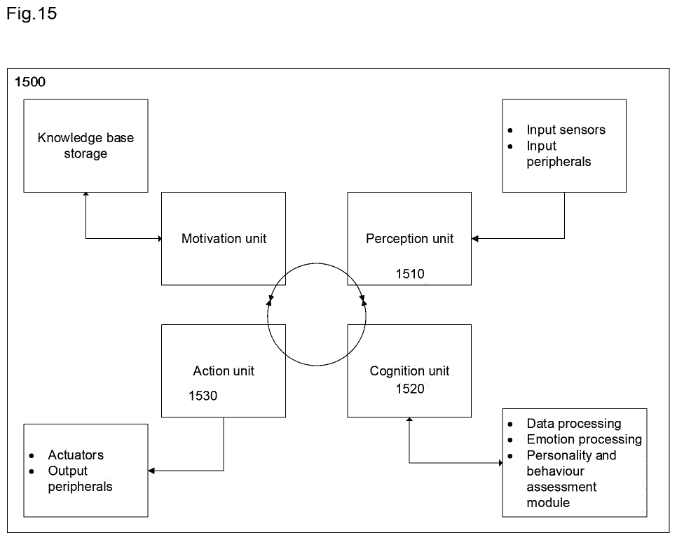

The robot 1430 would be interacting with humans 1410. Among other modules, the robot 1430 includes a number of input sensors which would allow the robot 1430 to capture the stimuli from the humans 1410 that the robot 1430 is interacting with. Among other sensors (e.g., position, humidity, temperature, movement, velocity, moisture, motion, proximity, distance) the robot 1430 includes one or more image capture devices 1420 (e.g., camera, optical cameras, thermal cameras), that allow the robot 1430 to capture images, static or dynamic, similar to what is described in context of FIG. 1. The images captured would then be processed analogously as indicated in FIG. 2, where the images are encrypted and sent to the server/s 1460 for processing. The server 1460 would receive the request and, as explained in context of FIG. 3, would execute the modules of user creation 320, image gathering 330, landmark detection module 340, facial measurements module 350 and personality prediction module 360. The output of the personality assessment 370 module would then be sent to the robot 1430. Upon receiving the personality assessment, the robot 1430 would process the personality assessment within its cognitive system as explained in context of FIG. 15, which would consequently could generate an action to be executed by the robot 1430, as explained herein. The robot/s (1430) may include locally all the logic and modules that are described here to be in the server/s 1460 and can themselves perform various processing, as described herein, to perform the personality assessment. Other system architectures are as well possible.

FIG. 15 schematically shows a cognitive architecture of a robot according to this disclosure. In particular, there is a cognitive architecture of a robot based on a PSI standard architecture. The robot, whether stationary, mobile, wheeled, tracked, floating, or flying, includes an image capture device (e.g., camera, optical camera, thermal camera) that captures an image of a person the robot is interacting via its perception unit 1510. For example, the robot can include an arm, a leg, a head, a face, a torso, a hand, a finger, an end effector, a body, or another portion that has a camera. The perception unit 1510 can include a module of the robot which contains some, many, most, or all the hardware, devices, peripherals, sensors and related software that enables the robot to capture inputs. These stimuli would then be transferred to a cognitive module 1520 of the robot in which the modules described above would be integrated. The images would be processed, standardized, landmarks identified, and measured. The information would be then transferred to a personality assessment module that would provide a personality assessment, as described herein. This assessment would then be used by an action module 1530 of the robot together with other inputs of other modules of the robot to perform actions. The actions can be communicate a message to a human verbally (e.g., via speaker) or by other means (e.g., via display or haptic interface), turn on a peripheral like moving an arm or leg or walk or run, or activating or deactivating or adjusting an arm, joint, lever, valve, actuator, motor, sensor, or other input, processing, or output device.

Some embodiments of this disclosure enable its usage in retailing so as to customized customer experience and product offering at the point of sales. As depicted in FIG. 1, some image capture devices would be installed in a retail store. When a customer would enter the store, then an image capture device would capture various images of the customer. Those images would then be processed, as explained herein. There is an output generated, where the output includes a list of products more aligned with that customer's personality and motivations. For example, in case a personality assessment concludes that the individual likes to enjoy pleasures like food, then relevant products can be showcased or recommended according to these likings. Analogously, if the personality assessment concludes that the individual is very rational and takes decision based on logical aspects, then there would be a change in the descriptions of the products highlighting the benefits and details of the product for a rational purchase.

Some embodiments of this disclosure would allow the user to obtain a number of identikits of individuals based on various relevant personality traits along with age range, gender and relevant psychological traits. For example, there would be a proposal of some images of physical facial aspect of someone based on some specific personality traits such as impulsivity, orientation to detail, sensitivity, sociability, or others.

In addition, features described with respect to certain example embodiments may be combined in or with various other example embodiments in any permutations! or combinatory manner. Different aspects or elements of example embodiments, as disclosed herein, may be combined in a similar manner. The term “combination”, “combinatory,” or “combinations thereof as used herein refers to all permutations and combinations of the listed items preceding the term. For example, “A, B, C, or combinations thereof is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code can be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to be-come coupled to other data processing systems or remote printers or storage devices through intervening private or public networks. Modems, cable modems, and Ethernet cards are just a few of the available types of network adapters.

The present disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a port-able compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or pro-gram statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer soft-ware, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various embodiments of the present disclosure in this regard, each block in the flowchart or block diagrams may represent a module, segment, or portion of instructions, which comprises one or more executable instructions for implementing the specified logical function(s). in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Features or functionality described with respect to certain example embodiments may be combined and sub-combined in and/or with various other example embodiments. Also, different aspects and/or elements of example embodiments, as dis-closed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required be-fore, after, and/or concurrently with example embodiments, as disclosed herein. Note that any and/or ail methods and/or processes, at least as disclosed herein, can be at least partially performed via at least one entity or actor in any manner.

Although preferred embodiments have been depicted and described in detail herein, skilled artisans know that various modifications, additions, substitutions and the like can be made without departing from spirit of this disclosure. As such, these are considered to be within the scope of the disclosure, as defined in the following claims.

What is claimed is:

1. A method comprising:
requesting, by a processor, a first image to be captured by a camera, wherein the first image depicts a face of a user;
identifying, by the processor, a set of facial landmarks in the first image;
determining, by the processor, a first set of measurements based on the set of facial landmarks, wherein each measurement from the first set of measurements is between at least two facial landmarks from the set of facial landmarks;
searching, by the processor, a data structure for a second set of measurements matching the first set of measurements in the data structure;
identifying, by the processor, the second set of measurements in the data structure matching the first set of measurements in the data structure;
identifying, by the processor, a personality trait in the data structure corresponding to the second set of measurements in the data structure;
writing, by the processor, the personality trait into a profile associated with the user;
requesting, by the processor, a second image to be captured by the camera, wherein the second image depicts the face of the user;
identifying, by the processor, the face of the user in the in second image;
reading, by the processor, the personality trait from the profile; and
requesting, by the processor, at least one of a valve, an actuator, or a motor to act, not act, or adjust action based on the personality trait being read from the profile.

2. The method of claim 1, wherein the processor, the camera, and the at least one of the valve, the actuator, or the motor are housed within a robot.

3. The method of claim 2, wherein the at least one of the valve, the actuator, or the motor is the valve.

4. The method of claim 3, wherein the processor requests the valve to act.

5. The method of claim 3, wherein the processor requests the valve not to act.

6. The method of claim 3, wherein the processor requests the valve to adjust action.

7. The method of claim 2, wherein the at least one of the valve, the actuator, or the motor is the actuator.

8. The method of claim 7, wherein the processor requests the actuator to act.

9. The method of claim 7, wherein the processor requests the actuator not to act.

10. The method of claim 7, wherein the processor requests the actuator to adjust action.

11. The method of claim 2, wherein the at least one of the valve, the actuator, or the motor is the motor.

12. The method of claim 11, wherein the processor requests the motor to act.

13. The method of claim 11, wherein the processor requests the motor not to act.

14. The method of claim 11, wherein the processor requests the motor to adjust action.

15. The method of claim 1, wherein the measurement is a distance between the at least two facial landmarks.

16. The method of claim 1, wherein the measurement is a ratio between the at least two facial landmarks.

17. The method of claim 1, wherein the measurement is an angle between the at least two facial landmarks.

18. The method of claim 1, wherein the first image is a set of photos of the face from a set of angles that are different from each other.

19. The method of claim 18, wherein the set of angles includes a profile photo of the face, a frontal photo of the face, and a perspective photos of the face.

20. The method of claim 1, wherein each measurement from the first set of measurements is between at least three facial landmarks from the set of facial landmarks.

21. The method of claim 1, wherein the data structure is a table.
